(19) United States
(12) Patent Application Publication
(10) Pub. No.: US 2008/0082403 A1
(43) Pub. Date: Apr. 3, 2008

(54) Method for providing customized information for using a public transportation system

(76) Inventors: Olasunkanmi John Adegoke, Chateauguay (CA); Wei-Han Frank Lin, Montreal (CA)

Correspondence Address: OGILVY RENAULT LLP, 1981 MCGILL COLLEGE AVENUE, SUITE 1600, MONTREAL, QC, H3A2Y3, US

(21) Appl. No.: 11/528,682

(22) Filed: Sep. 28, 2006

(51) Int. Cl. G06Q 30/00; G06Q 10/00

(52) U.S. Cl. 705/14; 705/5

(57) ABSTRACT

A method for providing customized scheduling information for using a public transportation system, the method comprising providing a schedule request for reaching an intended destination using, the schedule request comprising a temporal indication, generating advertising data related to the schedule request and receiving a customized scheduling information comprising a generated schedule for reaching the intended destination, the customized scheduling information further comprising the advertising data.

### CROSS-REFERENCE TO RELATED APPLICATIONS

This is the first application filed for the present invention.

### STATEMENT REGARDING FEDERALLY SPONSORED RESEARCH OR DEVELOPMENT

Not Applicable.

### TECHNICAL FIELD

This invention relates to the field of data processing units. More precisely, this invention pertains to a method for providing customized information for using a public transportation system.

### BACKGROUND OF THE INVENTION

Public transportation users of various public transportation systems are able, in some cases, to have access to information regarding the public transportation systems. The information is mostly limited to schedule information. The users are typically able to access such data via a computer and the Internet.

Unfortunately such schedule information is usually very cumbersome and does not provide a lot of added values to the users.

The public transportation users are therefore left with very few information aside time and location and the public transportation system per se.

There is a need for a method and apparatus that will overcome at least one of the above-mentioned drawbacks.

### SUMMARY OF THE INVENTION

According to one aspect of the invention, there is provided a method for providing customized scheduling information for using a public transportation system, the method comprising providing a schedule request for reaching an intended destination using said public transportation system, the schedule request comprising a temporal indication, generating advertising data related to the schedule request and receiving a customized scheduling information comprising a generated schedule for reaching the intended destination, the customized scheduling information further comprising the advertising data.

According to a further aspect of the invention, there is provided an apparatus for providing customized scheduling information for using a public transportation system, the apparatus comprising an advertising database for providing an advertising data signal, a schedule database for providing a schedule data signal, a server unit for receiving a schedule request signal for reaching an intended destination using the public transportation system, the schedule request signal comprising a temporal indication, the server unit further generating and providing the customized scheduling information using the received schedule request signal, corresponding schedule data signal and corresponding advertising data signal.

### BRIEF DESCRIPTION OF THE DRAWINGS

Further features and advantages of the present invention will become apparent from the following detailed description, taken in combination with the appended drawings, in which:

FIG. 1 is a block diagram of a system for providing customized scheduling information for using a public transportation system; the system comprises an advertiser server unit, a server unit, a schedule data providing unit, a user database, an advertising database and a schedule database;

FIG. 2 is a flow chart which shows how to provide customized scheduling information for using a public transportation system according to one embodiment; according to a first step, a schedule request is provided, according to a second step, advertising data related to the schedule request is generated and according to a third step, customized scheduling information is provided;

FIG. 3 is a flow chart which shows how a schedule request is provided; according to a first step, one of an indication of a location to reach and a transportation means to use is entered; according to a second step, a temporal indication is provided;

FIG. 4 is a flow chart which shows how advertising data related to the schedule request is generated; according to a first step, a transportation schedule database is accessed; according to a second step, schedule data is retrieved; according to a third step, an advertising data is accessed and according to a fourth step, corresponding advertising data is retrieved;

FIG. 5 is a flow chart which shows how the customized scheduling information is provided according to one embodiment; according to a first step, generated advertising data is provided; according to a second step, the schedule data is provided; according to a third step, the schedule data is merged with the generated advertising and according to a fourth step, the generated customized scheduling information is provided;

FIG. 6 is a flow chart which shows how the schedule is provided according to one embodiment; according to a first step, a schedule database is accessed, according to a second step, a schedule is computed and according to a third step, the computed schedule is provided.

It will be noted that throughout the appended drawings, like features are identified by like reference numerals.

### DETAILED DESCRIPTION

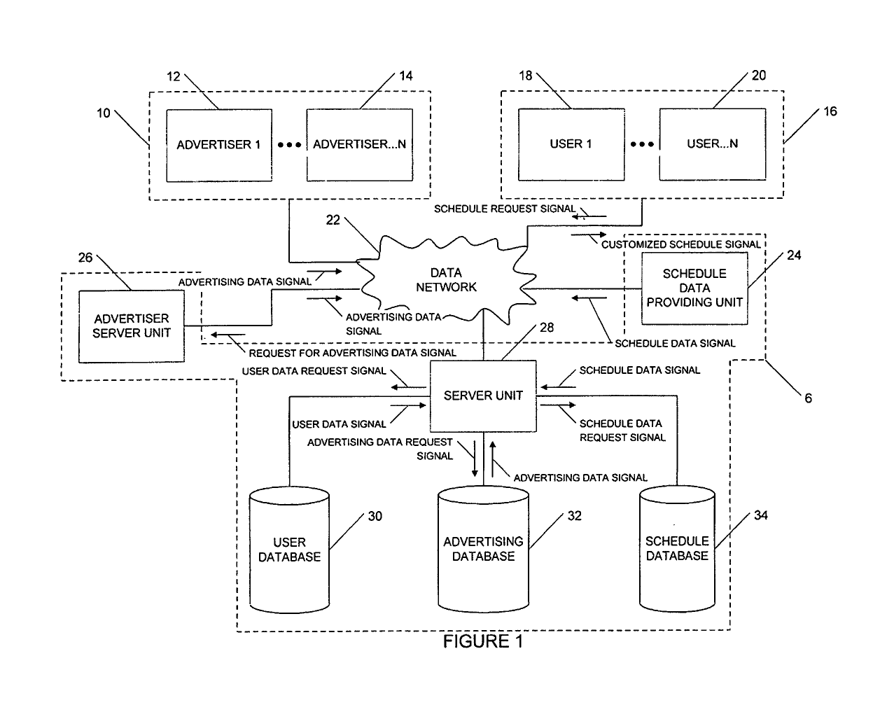

Now referring to FIG. 1, there is shown an embodiment of a system 6 for providing customized scheduling information for using a public transportation system. The public transportation system may be anyone of a subway, a bus network, a train network, an airline network, a light rail system, a ferry/boat shuttle or like.

The system 6 comprises a schedule data providing unit 24, an advertiser server unit 26, a server unit 28, a user database 30, an advertising database 32 and a schedule database 34.

As shown in FIG. 1, a plurality of users 16 comprising in the embodiment disclosed user 1 18 and user N 20 are connected to a data network 22.

A plurality of advertisers 10 comprising in the embodiment disclosed advertiser 1 12 and advertiser N 14 are connected to the data network 22. The schedule data providing unit 24, the server unit 28 and the advertising server unit 26 are also connected to the data network 22 according to one embodiment.

More precisely, the data network 22 may be any type of network enabling the providing of data. In one embodiment, the data network 22 may comprise at least one of a local area network (LAN), a metropolitan area network (MAN) and a wide area network (WAN). In one embodiment the data network 22 comprises the Internet. Alternatively, the data network 22 may comprise any wired or wireless messaging protocols.

Each of the plurality of users 16 comprises a processing unit, not shown in FIG. 1 and further having communication means for enabling a communication with the data network 22. The processing unit may be any one of a personal data assistant (PDA), a laptop computer, a desktop computer, a smart phone, a cell-phone or the like. In one embodiment, the communication means comprises one of Short Message Services (SMS), Wireless Application Protocol (WAP) and Wireless Fidelity (WiFi).

Each advertiser of the plurality of advertisers 10 comprises a processing unit, not shown in FIG. 1 and further having communication means for enabling a communication with the data network 22. In one embodiment, the processing unit may be any one of a desktop computer, a laptop computer, a tablet PC or the like.

The plurality of users 16 provides a schedule request signal to the server unit 28 via the data network 22 and receives a customized schedule signal from the server unit 28 via the data network 22.

The schedule data providing unit 24 provides a schedule data signal to the server unit 28 via the data network 22. The schedule data signal is related to the public transportation system. It will be appreciated that the schedule data signal comprises data pertinent to a schedule and is dependent on a public transportation system. It will be further appreciated that the schedule data signal may be provided to the schedule database 34 using anyone of a push or a pull technique, in a manual as well as in an automatic fashion. In one embodiment, the schedule data providing unit 24 is implemented at the public transportation system. Furthermore, it will be appreciated by the skilled addressee that the schedule data signal is provided to the schedule database 34 using authentication/encryption means as in one embodiment the data network 22 comprises the Internet. The advertiser server unit 26 receives a request for advertising data signal from the server unit 28 via the data network 22 and provides an advertising data signal to the server unit 28 via the data network 22. It will be appreciated that the server unit 28 may be any type of server and may operate using various operating systems such as Microsoft™ Windows™, Unix™, Linux, Mac OS™ or the like.

More precisely, the server unit 28 provides a schedule data request signal to a schedule database 34 and receives a schedule data signal from the schedule database 34.

The schedule database 34 is adapted to store schedule data comprising temporal information as well as geographical information for the public transportation system. It will be appreciated that the schedule database 34 may be self-updated.

The advertising database 32 comprises advertising data. It will be appreciated by the skilled addressee that the advertising data may be related to a temporal location as well as a geographical location. Moreover, the skilled addressee will appreciate that the advertising database 32 may be populated in one embodiment by the advertiser server unit 26 via the data network 22 and the server unit 28.

The user database 30 comprises information about the users of the system. It will be appreciated that the user database 30 may be optional. More precisely, the user database 30 receives a user data request signal from the server unit 28 and provides a corresponding user data signal.

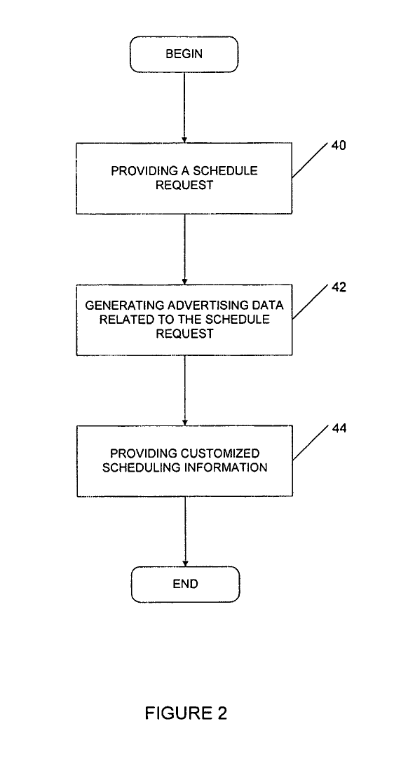

Now referring to FIG. 2, there is shown an embodiment for providing customized scheduling information.

According to step 40, a schedule request is provided. The schedule request is provided by a user of the plurality of users 16. In one embodiment, the schedule request is provided through a cellular phone using a short message service (SMS). Alternatively, the schedule request is sent using a web browser. The skilled addressee will appreciate that the schedule request may be sent using various methods.

According to step 42, advertising data related to the schedule request is generated. It will be appreciated that the advertising data is related to the schedule request and may comprise an indication of a day, a time and a place, it may also be related to a user profile in one embodiment. It will be appreciated that the advertising data may be at least one of text data, graphics data, video data, sound data or the like depending on the processing unit of a user. It will be further appreciated that the advertising data may comprise various types of marketing materials such as coupons, gift certificates, coupon numbers or instant rebates for instance.

According to step 44, customized scheduling information is provided. In one embodiment, customized scheduling information is provided to the user providing the schedule request. It will be appreciated that the customized scheduling information comprises a combination of advertising data related to a schedule request together with a schedule. The skilled addressee will appreciate that this is of great advantage as it enables a user to have access to valuable and targeted data. The data is not only targeted with respect to a physical location but it may also be targeted with respect to a time location.

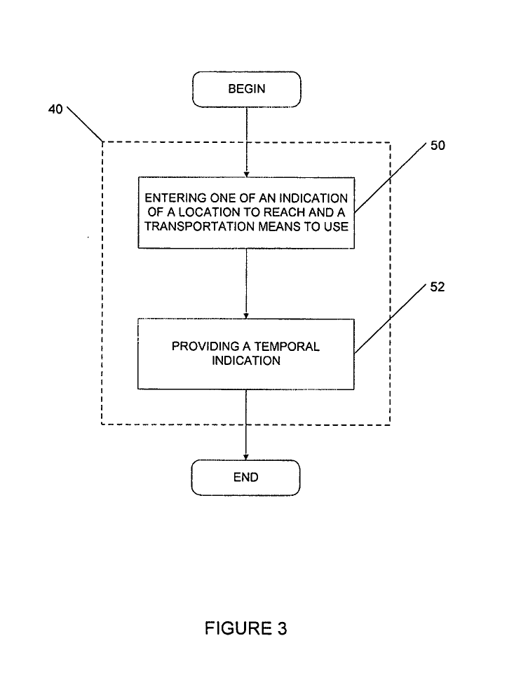

Now referring to FIG. 3, there is shown one embodiment for providing a schedule request. According to step 50, one of an indication of a location to reach in the transportation and an indication of a transportation means to use is entered. A location may be any type of physical location such as street, an intersection, a bus stop unique ID number, landmarks, a known place or the like. It will be appreciated that reverse-look up, e.g. using the Bus Stop unique ID to locate restaurant, banks, stores, etc may be used. As an illustration, if someone is new to a city, and knows the unique ID of a bus stop, a list of destinations, such as shopping, restaurants, on-going sales or deals at nearby stores, may be provided to him if he enters the unique ID of the bus stop. This can be done only with the unique ID of the bus stop. A transportation means may be any one of a means used to move in the public transportation system. As explained previously, the one of the indication of the location to reach and the transportation means to use is entered by a user of the plurality of users. It will be appreciated that a search may be performed using a drill-down approach. To that extent it is of great advantage to provide one of an indication of a location to reach in the transportation and an indication of a transportation means to use. For instance, a user may perform a request for a bus numbered 211. The user may then select for a direction such as North or South for instance. The user may then continue to drill-down to list of stops. The skilled addressee will appreciate that each drill-down search result provides an opportunity for advertising. Moreover it has been contemplated that a drill-down search is very efficient for providing results to a processing unit having limited processing power or display size such as a cell-phone for instance.

According to step 52, a temporal indication is provided. It will be appreciated that the temporal indication might be provided by a user who enters it manually through his processing unit or it might be provided transparently without user consent using, for instance, the internal clock of the processing unit of the user. The user may also desire to enter a temporal location depending on specific needs or intended time of use of the public transportation system. It will be appreciated by the skilled addressee that the temporal indication is of great interest in order to provide customized scheduling information.

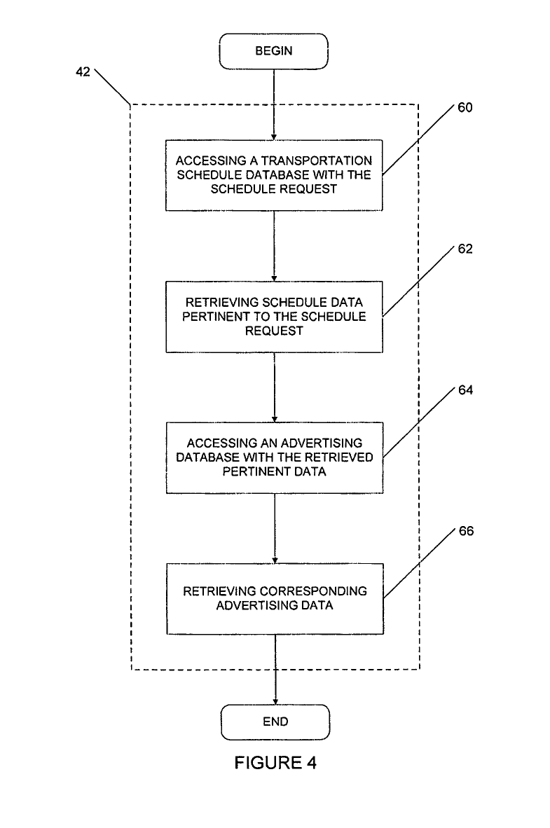

Now referring to FIG. 4, there is shown one embodiment for generating advertising data related to the schedule request. According to step 60, a transportation schedule database is accessed with the schedule request. In one embodiment, the transportation schedule database is accessed by the server unit 28.

According to step 62, schedule data pertinent to the schedule request is retrieved. In one embodiment, the schedule data pertinent to the schedule request is retrieved from the schedule database 34 by the server unit 28.

According to step 64, an advertising database is accessed with the retrieved pertinent data. In one embodiment, the advertising database is accessed with the retrieved pertinent data using the server unit 28.

According to step 66, corresponding advertising data is retrieved from the advertising database 32 in a response to the access of the advertising database 32.

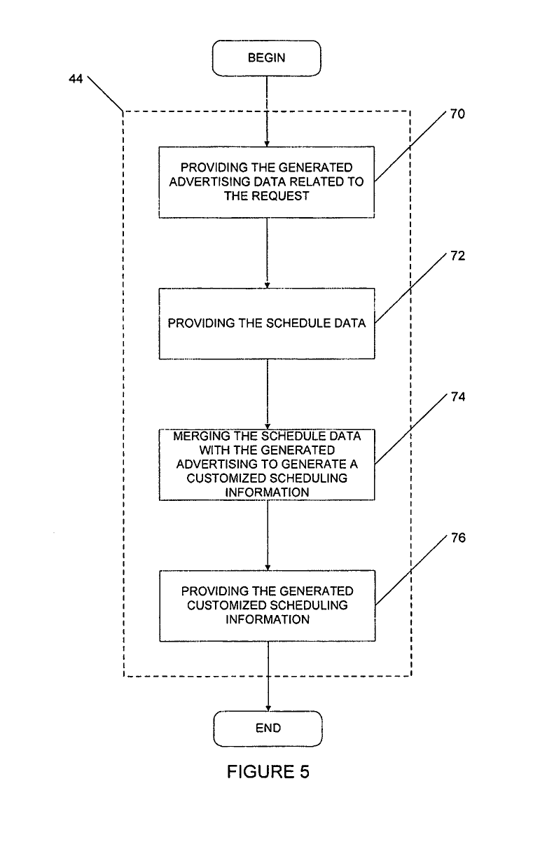

Now referring to FIG. 5, there is shown one embodiment for providing customized scheduling information. According to step 70, the generated advertising data related to the request is provided.

According to step 72, the schedule data is provided.

According to step 74, the schedule data is merged with the generated advertising data to generate a customized scheduling information.

According to step 76, the generated customized scheduling information is provided. In one embodiment, the generated customized scheduling information is provided to the user.

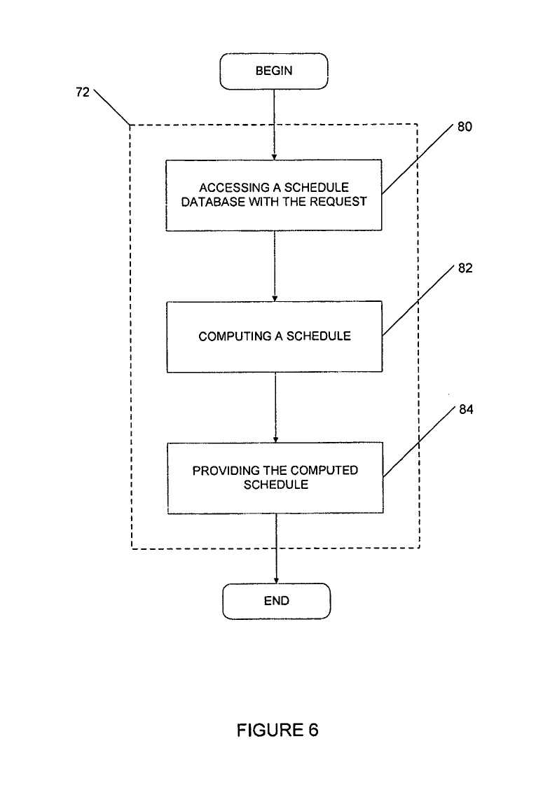

Now referring to FIG. 6, there is shown one embodiment for providing the schedule data.

According to step 80, the schedule database is accessed with a request.

According to step 82, a schedule is computed. It will be appreciated that the schedule might be computed using various algorithms by the server unit 28 in response to the schedule data signal provided by the schedule database 34 to the server unit 28.

According to step 84, the computed schedule is provided.

Referring back to FIG. 1, it will be appreciated that using the embodiment disclosed an advertiser of the plurality of advertisers 10 may be able to precisely advertise according to specific criteria. The criteria may include time and location, seasons (e.g. school season) and month. Moreover, the advertiser may be able to manage an advertisement campaign in a flexible way using a connection to the advertiser server unit 26. For instance, an advertiser may be able to control the time, duration and location of an advertisement or ad. The skilled addressee will appreciate that each of the plurality of advertisers 10 may access remotely the advertiser server unit 26. In one embodiment, the accessing is performed via the data network 22. The skilled addressee will further appreciate that the accessing is performed using encryption and authentication means such as Virtual Private Networks (VPN), Secure Socket Layer (SSL), a login/password combination or the like. The accessing of the advertiser server unit 26 may be used by a given advertiser to provide advertising data which is then used to populate the advertising database 32 via the server unit 28. Using such accessing, an advertiser of the plurality of advertisers 10 may alternatively amend or update corresponding advertising data. It will be appreciated that this enables a flexible way to achieve the management of advertising data.

The advertiser may also be able to control an advertising time which may be based on transit user usage. Furthermore, it will be appreciated that the advertiser may buy specified places as well as a route in the public transportation system depending on specific needs or events. It will be further appreciated that the advertiser may also request and, on payment of appropriate fees, receive a report indicative of usage/user profiles or the result of a specific campaign. The report may comprise a number of hits, user demographics, time, location or the like. It will be further appreciated that online payment methods may further be implemented on the advertiser server unit 26 for instance and may enable the advertiser to easily complete the transaction of buying advertisement on the system. For instance, the online payment methods may comprise Paypal, wire transfer, credit card payment using Secure Socket Layer or the like, or any kind of electronic payment system.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electro-magnetical signal.

The embodiment(s) of the invention described above is(are) intended to be exemplary only. The scope of the invention is therefore intended to be limited solely by the scope of the appended claims.

We claim:

1. A method for providing customized scheduling information for using a public transportation system, said method comprising:
providing a schedule request for reaching an intended destination using said public transportation system, said schedule request comprising a temporal indication;
generating advertising data related to said schedule request; and
receiving a customized scheduling information comprising a generated schedule for reaching said intended destination, said customized scheduling information further comprising said advertising data.

2. The method as claimed in claim 1, wherein said public transportation system comprises at least one of a subway, a bus network, a train network, an airline network, a light rail system and a ferry/boat shuttle.

3. The method as claimed in claim 1, wherein said providing of said schedule request comprises entering one of an indication of a location to reach and a transportation means to use.

4. The method as claimed in claim 3, wherein said location comprises at least one of a street, an intersection, a known place, a bus stop unique ID number and a landmark.

5. The method as claimed in claim 1, wherein said temporal indication is provided manually by a user.

6. The method as claimed in claim 1, wherein said temporal indication is provided transparently without a user consent.

7. The method as claimed in claim 1, wherein said providing of said schedule request comprises connecting to a server unit via a data network and transmitting said schedule request.

8. The method as claimed in claim 7, wherein said data network comprises at least one of a local area network (LAN), a metropolitan area network (MAN) and a wide area network (WAN).

9. The method as claimed in claim 8, wherein said data network comprises the Internet.

10. The method as claimed in claim 8, wherein said connecting is performed using a cellular phone, further wherein said transmitting said schedule request is performed using at least one of a Short Message Service (SMS) and a Web browser data request.

11. The method as claimed in claim 1, wherein said generating of said advertising data comprises accessing a transportation schedule database with the schedule request, retrieving schedule data pertinent to said schedule request, accessing an advertising database with the retrieved pertinent data and retrieving corresponding advertising data.

12. The method as claimed in claim 11, wherein said receiving of said customized scheduling information comprises merging said schedule data with the generated advertising data to generate a customized scheduling information and providing said generated customized information.

13. The method as claimed in claim 1, further comprising providing a modified schedule request in view of said received customized scheduling information.

14. The method as claimed in claim 1, wherein said generating of said advertising data comprises an advertiser providing advertising data over a data network.

15. An apparatus for providing customized scheduling information for using a public transportation system, said apparatus comprising:
an advertising database for providing an advertising data signal;
a schedule database for providing a schedule data signal;
a server unit for receiving a schedule request signal for reaching an intended destination using the public transportation system, said schedule request signal comprising a temporal indication, said server unit further generating and providing said customized scheduling information using said received schedule request signal, corresponding schedule data signal and corresponding advertising data signal.

16. The apparatus as claimed in claim 15, further comprising a schedule data providing unit for providing said schedule data signal to said schedule database.

17. The apparatus as claimed in claim 16, wherein said schedule data providing unit provides said schedule data signal to said schedule database over a data network.

18. The apparatus as claimed in claim 17, wherein said data network comprises at least one of a local area network, a metropolitan area network and a wide area network.

19. The apparatus as claimed in claim 18, wherein said data network comprises the Internet.

20. The apparatus as claimed in claim 15, further comprising an advertiser server unit for providing said advertising data signal.

21. The apparatus as claimed in claim 20, wherein said advertiser server unit provides said advertising data signal to said advertising database over a data network.

22. The apparatus as claimed in claim 21, wherein said data network comprises at least one of a local area network, a metropolitan area network and a wide area network.

23. The apparatus as claimed in claim 22, wherein said data network comprises the Internet.

24. The apparatus as claimed in claim 15, wherein said schedule request signal is provided by a user over a data network, further wherein said customized scheduling information is provided to said user over said data network.

25. The apparatus as claimed in claim 24, wherein said data network comprises at least one of a local area network, a metropolitan area network and a wide area network.

26. The apparatus as claimed in claim 25, wherein said data network comprises the Internet.

27. The apparatus as claimed in claim 15, wherein said advertiser server unit is accessed by an advertiser, providing said advertising data signal, via a data network.

28. The method as claimed in claim 1, wherein said providing of said customized scheduling information is performed for a fee charged to an advertiser providing said advertising data.
